(19) United States
(12) Patent Application Publication
(10) Pub. No.: US 2010/0001586 A1
(43) Pub. Date: Jan. 7, 2010

(54) Method and system for managing backup power

(75) Inventors: Marc R. Bernard, Miramar, FL (US); Douglas A. Atkinson, Ashburn, VA (US); Jeffrey A. Rosenwald, Frederick, MD (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/217,177

(22) Filed: Jul. 2, 2008

(51) Int. Cl. H02J 9/00

(52) U.S. Cl. 307/65

(57) ABSTRACT

Typical battery backup solutions for network devices provide power for a limited range of services over a limited duration, and lack user serviceability. A configurable, redundant battery solution according to an example embodiment of the invention employs two or more battery backup units (BBUs) available to a device. The device and BBUs are responsive to respective configuration data directing usage of the BBUs and/or operation of the device. In the event of a power failure, the BBUs provide power to the device based on their respective configuration data. Through use of the at least one embodiment, an Optical Network Terminal (ONT) in a Passive Optical Network (PON) can be configured by a service provider to provide eight hours of emergency dial-out call service and configured by a user to provide other services, such as Internet Protocol Television (IPTV) and data services, in a customized manner during a backup power condition.

### BACKGROUND OF THE INVENTION

A passive optical network (PON) can include multiple Optical Line Terminals (OLTs), each connected by a shared optical fiber to a respective Optical Distribution Network (ODN) with multiple Optical Network Terminals (ONTs) on respective optical fibers. Such networks are commonly implemented and maintained by service providers providing one or more network-based communications services, such as a telephone service, Internet access service, or television service. The PON operates as a constituent of one or more larger networks, extending access to those networks to a number of customers of the service provider. An ONT typically terminates the PON at or near a customer's premises, thereby enabling the customer to connect to the ONT with a telephone, modem, set-top box or other connective device to access subscriber services.

Active components of the network, such as the ONT, are usually powered by an available alternating current (AC) power source, such as an AC line source of a local power grid. In order to improve reliability and provide continued service in the event of a power failure, ONTs are often configured with an internal or external battery backup unit (BBU). The BBU typically includes a battery and circuitry to transition the ONT to battery power in response to an interruption in AC line power. Because the battery is limited in its capacity to power a range of services supported by the ONT, this transition often results in the loss of some services to the customer, as well as the eventual loss of all services. For example, a telephone service may have priority over an Internet service, particularly during a power failure or other emergency, and so may be supported during a power failure at the expense of Internet access and other services. Thus, the BBU enables the ONT to provide limited access to communications services for a limited time following a power failure.

### SUMMARY OF THE INVENTION

Example embodiments of the present invention provide redundant, configurable, battery backup units (BBUs) to expand and extend operations of a device in the event of a power failure. At least a first and a second BBU are available to power the device, and the device is configured to draw power from the BBUs according to respective configuration data. The configuration data may, for example, direct the device to operate in a specified mode or support particular services based on the availability and status of the BBUs. The configuration data may be stored at the device or another location. In an event of a failure of a primary power source (e.g., AC line power), the BBUs provide power to the device by at least one of the first and second backup power sources according to the stored configuration data.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an optical network in which embodiments of the present invention may be implemented.

FIG. 2A is a block diagram of an Optical Network Terminal (ONT) employing an embodiment of the present invention.

FIG. 2B is a block diagram of an Optical Network Terminal (ONT) employing an embodiment of the present invention.

FIG. 3A is a table illustrating an example configuration of services based on battery availability.

FIG. 3B is a table illustrating an example configuration of services based on availability of combinations of battery backup units (BBUs).

FIG. 3C is a table illustrating an example configuration of services determined by a selection of power levels and available BBUs.

FIG. 4 is a block diagram of a procedure to configure services as a function of available BBUs.

FIG. 5A is a block diagram of a procedure to configure services to be supported by multiple BBUs and provide power in the event of a power failure.

FIG. 5B is a block diagram of a procedure to monitor power availability and utilize one or more BBUs according to stored configuration data.

### DETAILED DESCRIPTION OF THE INVENTION

A description of example embodiments of the invention follows.

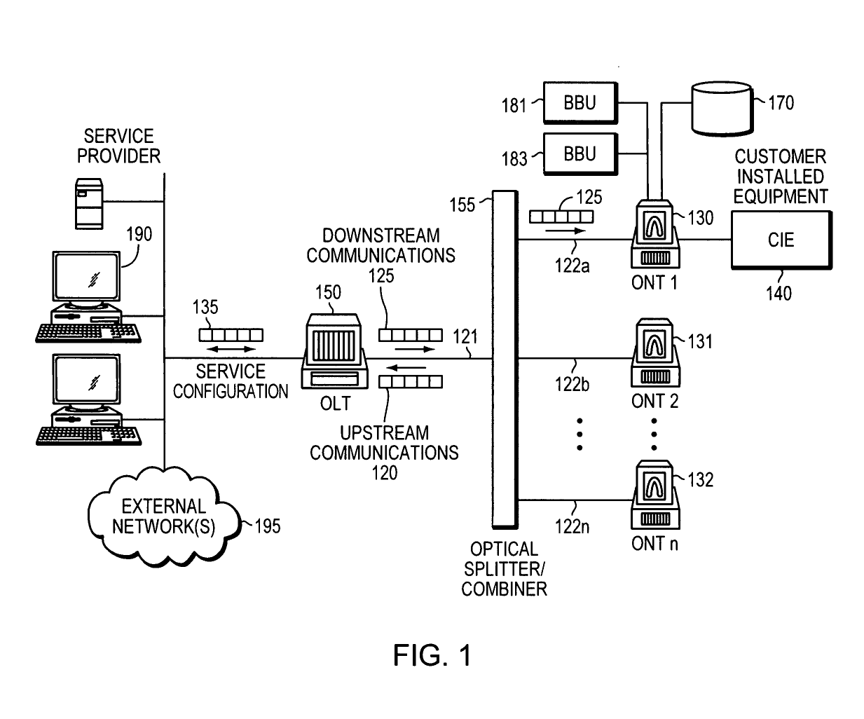

FIG. 1 is a block diagram of an optical network 100 having a number of network nodes, including optical network terminals (ONT) 130-132, optical line terminal (OLT) 150, and service provider 190. ONTs 130-132 support upstream and downstream communications 120, 125 between the OLT 150 and customer installed equipment (CIE) 140, which may include one or more networked devices (not shown), such as computer workstations, wireless network access points, and Internet Protocol television (IPTV) set-top boxes. The OLT 150 further routes such communications 120, 125 across the network 100, which may include additional networked nodes (e.g., the Internet or additional optical channels, not shown) to and from a service provider network 190. The service provider 190 may provide one or more services to the CIE device(s), such as Internet access, Internet-Protocol television (IPTV), “plain old telephone service” (POTS), Voice-over Internet Protocol (VoIP), Cable television (CATV), and other communications services. In order to provide such services and deliver content as requested by a customer, the service provider 190, being located at a central office, supports further communications through one or more external networks 195, such as the Internet or telephone networks, to external content providers and network nodes (not shown).

The upstream and downstream communications 120, 125 include optical data bits that are transmitted in respective predefined timeslots. For example, in the case of a time division multiplexing (TDM) or time division multiple access (TDMA) communications protocol, communications data are placed into individual timeslots of an upstream communications frame 120. Implementing one such protocol, the optical network 100 may include a passive optical network (PON) to transmit communications between the OLT 150 and the ONTs 130-132.

The OLT 150 transmits downstream communications 125 via an optical line 121 to an optical splitter/combiner 155, which may be active or passive. The splitter/combiner 155 power divides the downstream communications 125 to the ONTs 130-132, as downstream communications 125. Due to a TDM or other multiplexing protocol, each ONT 130-132 receives the entire downstream communications 125, of which one or more segments may be addressed to the receiving ONT (e.g., ONT 130), and one or more other segments may be addressed to another ONT (e.g., ONT 131). The receiving ONT (e.g., ONT 130) processes the received downstream communications (e.g., 125), and routes communications segments to a corresponding CIE 140 configured to receive those communications segments. The ONTs 130-132 may discard communications segments that are addressed to a different ONT or other device not in communication with the ONTs 130-132.

Each of the ONTs 130-132 transmits upstream communications (e.g., 120), via respective optical lines 122a-n, to the optical splitter/combiner 155, which combines segments of upstream communications 120 in the order received to transmit a combined upstream communications frame 120 to the OLT 150. The OLT 150 further routes the upstream communications 120 to the service provider 190.

The ONTs 130-132 may be implemented in a number of configurations to support network services to the CIE 140 or other network nodes (not shown). For example, under a “Fiber to the Premises” (FTTP) configuration, a passive or active optical channel may connect the OLT 150 to an ONT (e.g., 130) located at a customer's premises, either indoors or outdoors within an enclosure. The ONT 130, in turn, routes communications to customer equipment at the premises (e.g., CIE 140) via one or more compatible mediums (e.g., copper, Ethernet, coaxial cable, etc.). Alternatively, a “Fiber to the Curb” (FTTC) configuration directs optical communications from an OLT 150 to an ONT (e.g., 130) located at a connection point (e.g., at an optical fiber terminal box) proximate to one or more customer premises. The ONT may further connect to customer equipment (e.g., CIE 140), via coaxial cable, twisted pair, or other medium, at one or more locations, thereby providing network access to a number of network subscribers local to the ONT.

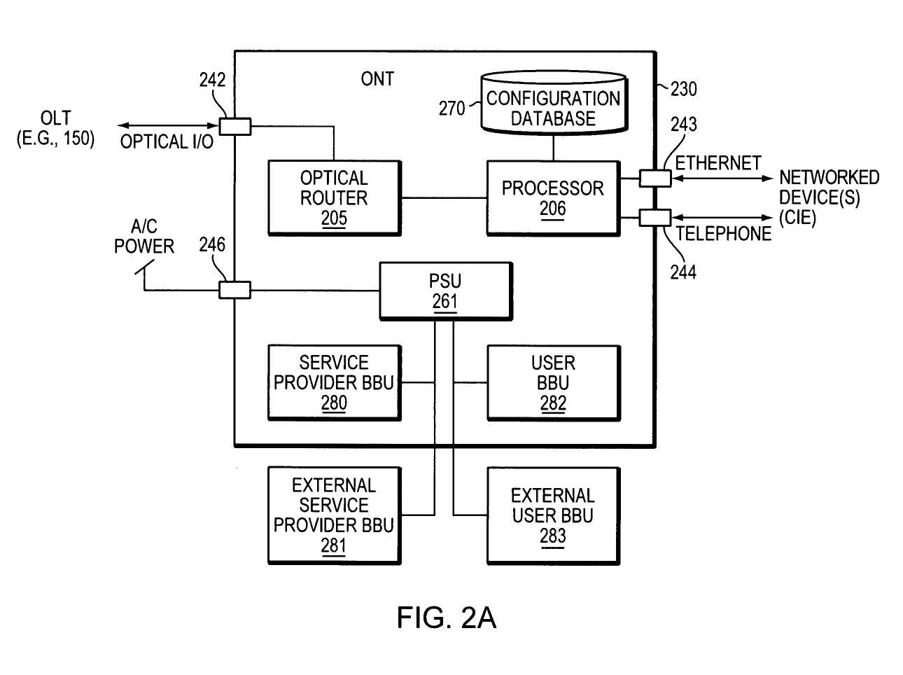

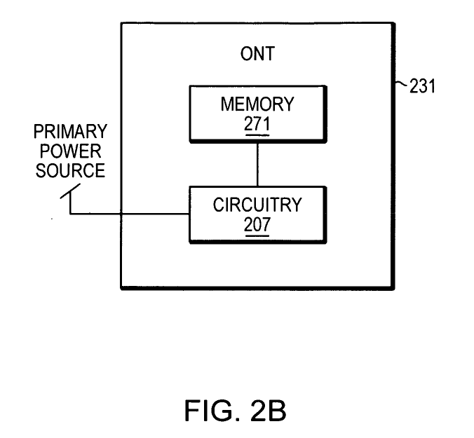

In order to improve reliability and to maintain operations in the event of a power failure, ONTs 130-132 typically are equipped with a battery backup unit (BBU) (not shown), which is typically installed by the service provider. Example BBUs are described in further detail below with reference to FIG. 2A. A BBU typically includes a rechargeable battery and a charger unit to monitor the status of the battery, charge the battery, and enable use of the battery by the ONT. An ONT and respective BBU may be preconfigured by the service provider such that, in the event of a power failure, the ONT continues to support a specified range of services while drawing power from the BBU. Due to the limited power or energy capacity of the BBU, the specified range of services may be narrower than a full range of services supported when the ONT is powered by a main power source (e.g., alternating current (AC) mains). For example, an ONT that normally supports a Plain Old Telephone Service (POTS), Ethernet-based Internet service (ENET) and IPTV service to connected customer equipment may be configured such that, in response to a main power failure, the ONT transitions its power supply to a respective BBU. This transition may be detected by upstream nodes (e.g., an OLT and service provider) as an interruption or failure of services rejected by the ONT, while continuing to support the POTS service to the customer. As a result, the customer continues to receive a telephone service for a limited time after a local power outage.

Typical battery backup installations for ONT and other network devices have a number of drawbacks. A battery, provided by the service provider, is normally installed within the ONT during installation of the ONT at or near a customer's premises. As indicated above, this service-provider battery suffers from limited capacity, which, in turn, requires the ONT to restrict supported services when relying on backup power. Moreover, even when the ONT operates with fewer services, the service-provider battery is able to support these services merely for a limited time, resulting in unsatisfactory “backup time” for use of one or more services. Yet, due to the ONT and integrated battery being under the domain of the service provider, a customer is unable to replace or supplement the battery to extend the backup time for continued services.

Such service-provider battery installations also cause difficulties for the service provider and can incur a cost that outweighs its benefit. For example, if an ONT 130 is installed in a network configuration as described above, the ONT 130 may be located at remote premises that are not easily accessible to the service provider. Once installed, maintenance of the battery by the service provider, particularly in response to a power outage, may be cost prohibitive. Further, ONTs may be installed in locations that prohibit the use of an integrated battery. An enclosure or sealed cabinet housing multiple ONTs, for example, may be subject to building codes or safety requirements that exclude battery installations. The service provider thus may be required to install ONTs without a battery backup or provide a (more costly) external battery backup unit.

Example embodiments of the present invention provide a configurable, redundant battery solution for an ONT or other devices. In some embodiments, at least a first and a second BBU are available to power a device, and the device is configured to draw power from the BBUs according to respective configuration data. The configuration data may, for example, direct the device to operate in a specified mode or support particular services based on the availability and status of the BBUs. The configuration data may be stored at the device or another location. In an event of a failure of a primary power source (e.g., AC line power), the BBUs provide power to the device by at least one of the first and second backup power sources according to the stored configuration data.

In reference to FIG. 1, for example, the ONT 130 may be connected to a first, service-provider BBU 181, as well as a second, user-provided BBU 183 integral with or external from the ONT 130. Configuration data, stored in a configuration table or database 170, as set by the customer or service provider, indicates one or more parameters directing how the ONT 130 may employ the BBUs 181, 183 in the event of a power failure. Such parameters may include, for example, services to support as a function of the availability and status of BBUs, priority of supported services, priority of BBUs to be used, duration of supported services, implementation of “low power” modes, enabling and disabling hardware components of the ONT, and communicating power status to the service provider or customer. This configuration data is stored at the ONT or at another network node. In response to a failure of the AC line power (e.g., an intermittent failure or power outage), the ONT 130 transitions to a backup power mode by utilizing the BBUs 181, 183 and operating according to the stored configuration data. The availability of multiple BBUs 181, 183, as well as the capability to configure use of the BBUs 181, 183 based on a customer's preferences and replace batteries as needed, provides for more useful and customizable battery backup solutions.

The configuration data may be set locally at the ONT 130, either by a customer or by a craft person through an interface at the ONT 130. The configuration data may also be set remotely. In one example, the customer may install a second BBU by connecting it to the ONT 130. The customer then inquires with the service provider as to what services and configurations are available and compatible with the expanded battery installation. Once a configuration is selected by the customer, the service provider 190 communicates corresponding service configuration data 135 downstream to the ONT 130. The ONT 130 or other device stores the configuration data 135, thereby updating its configuration in the event of a power failure. Alternatively, a customer may access the ONT 130 configuration data from connected customer installed equipment (CIE) 140, such as a computer terminal. The customer may view, modify and update the configuration data, the updated configuration data being stored at the ONT 130 or other device. The updated configuration data may also be communicated, for example, to the service provider 190 by transmitting the data 135 upstream, which may be useful in case the customer's ONT loses its configuration information, the service provider is requested to diagnose a problem remotely, or a management node is used to collect or track customer BBU configuration settings.

In further embodiments of the invention, one or more customer-provided BBUs may be implemented in the absence of a service-provider battery. Such an installation improves cost-efficiency for the service provider, and further enables the customer to install and configure a backup solution meeting the specific needs of the customer. The configuration data may also include multiple configuration data that are controlled separately by both the service provider and the customer. In this arrangement, the service provider may retain control over use of the service provider BBU and/or other BBUs to ensure a minimal level of services (e.g., emergency communications) during a power failure, while the customer controls the use of customer-provided batteries and/or BBUs to expand upon the minimal level of services. Further, the BBUs may include rechargeable and nonrechargeable batteries, such as alkaline, Nickel-cadmium (NiCd), Nickel-metal hydride (NiMH), and Lithium Ion batteries. The BBUs (and, by extension, their constituent batteries) may be connected in series or in parallel to accommodate the particular power requirements of the ONT and/or the services to be supported. The BBUs may be configured to provide backup power exclusively to the ONT, or may be adapted to provide backup power to additional devices, such as customer-installed equipment and other network nodes.

FIG. 2A is a block diagram of an Optical Network Terminal (ONT) 230 employing a redundant, configurable battery solution. ONTs 130-132, in FIG. 1, may be configured in a manner similar to the ONT 230. The ONT 230 communicates upstream with an OLT (e.g., OLT 150 in FIG. 1) or other network device via upstream optical port 242, which supports communications with an optical router 205 for receiving and transmitting optical communications at the port 242. Those communications may be received by the processor 206 in a digital mode, which, in turn, routes communications downstream to one or more networked devices, such as a computer terminal or telephone, via an Ethernet port 243, POTS port 244 or other compatible ports (not shown). Power to the ONT 230 may be provided primarily by an AC line power source coupled to the power outlet 246. The power supply unit (PSU) 261 transforms the received AC line power and distributes power to components of the ONT 230.

In the event that the AC line power is unavailable or insufficient, the PSU 261 transitions to draw upon one or more battery backup units (BBUs) 280-283 to supply power to the ONT 230. The BBUs include an internal service provider BBU 280, external service provider BBU 281, internal user-provided BBU 282, and external user provided BBU 283. The ONT 230 may include more or fewer BBUs that are internal, external, user-provided or service-provider provided. Although a typical BBU may include a battery and circuitry to charge, monitor and report status of the battery, such functionality may reside at each of the BBUs 280-283, or may be shared by the PSU 261, processor 206 or other module. For example, the internal BBUs 280, 282 may include a battery or batteries, the PSU 261 providing monitoring and charging the batteries. In contrast, the external BBUs 281, 283 may include a separate enclosure containing a battery and circuitry to charge and monitor/report status of the battery.

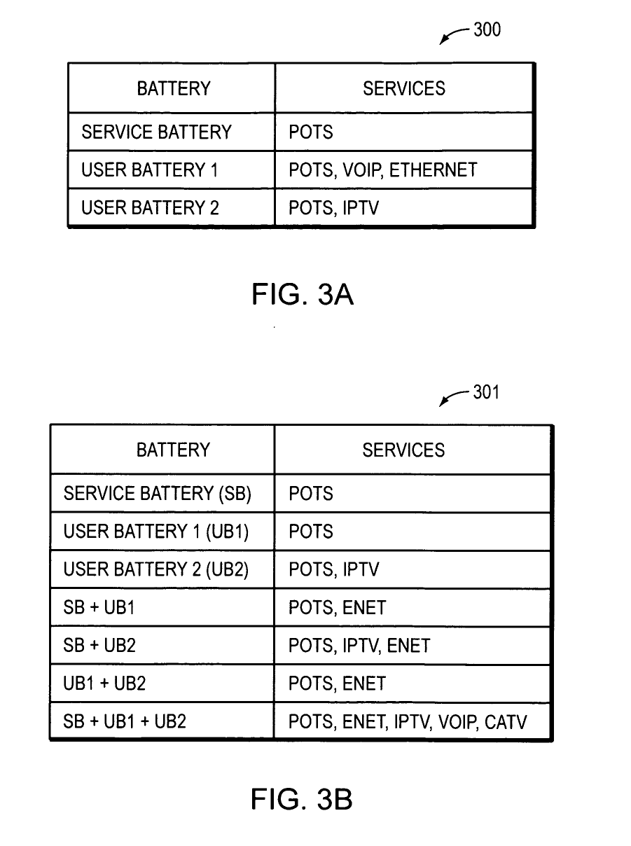

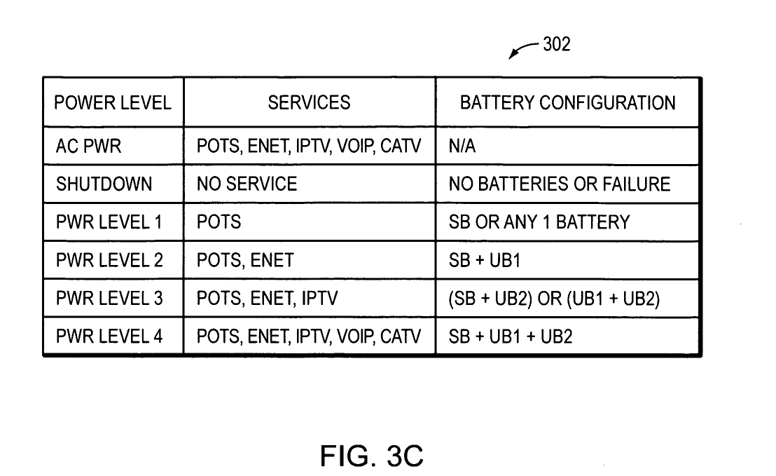

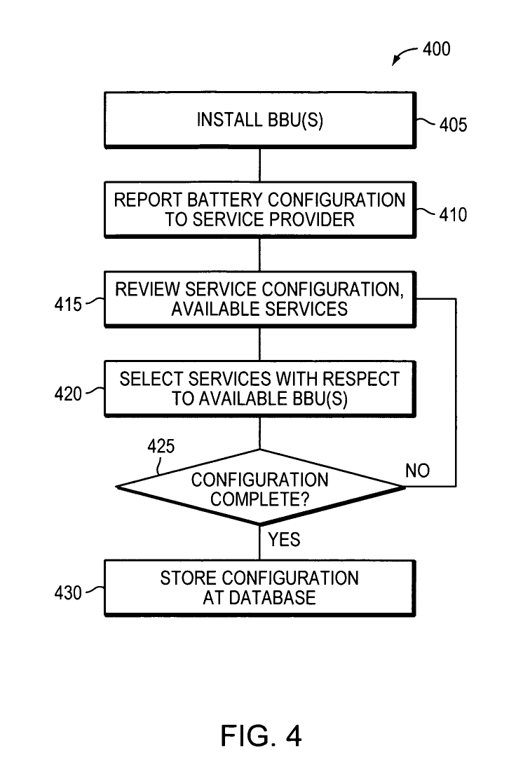

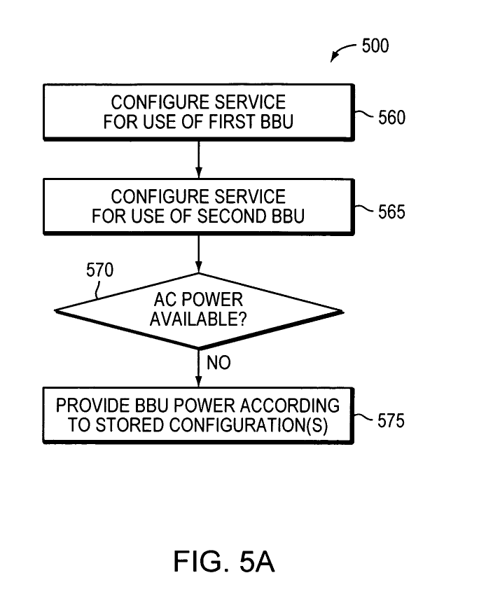

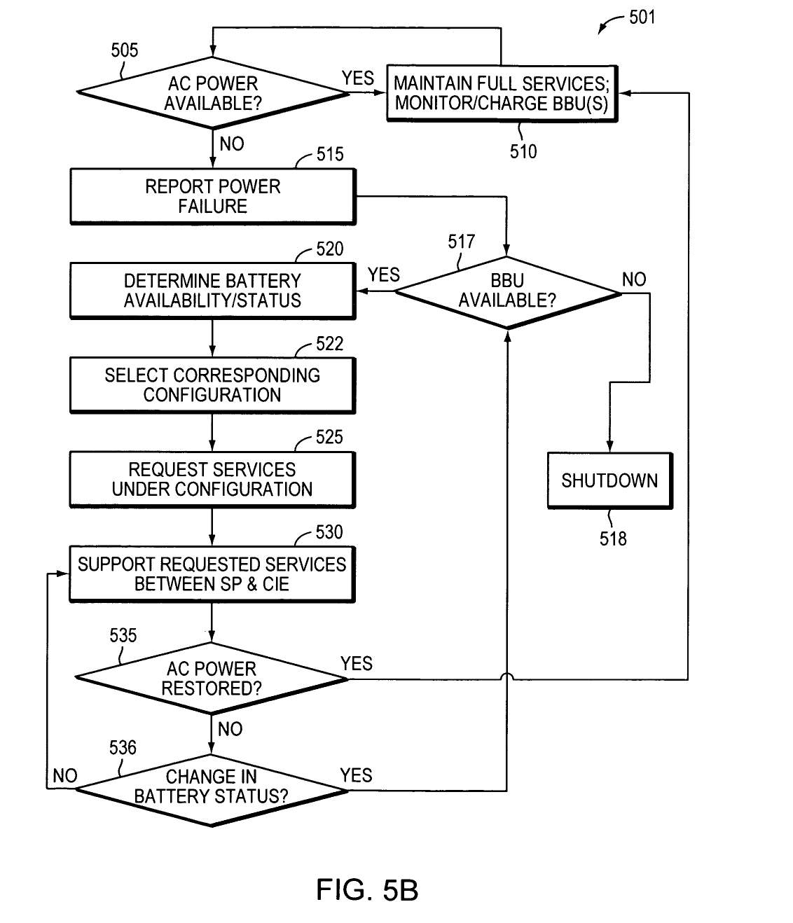

The ONT 230 may be configured to operate and utilize available BBUs 280-283 based on configuration data regarding backup power operation. With respect to such configuration data, the ONT 230 may operate as described above with reference to the ONT 130 of FIG. 1. The configuration data may be stored to a computer-readable medium (e.g., RAM, ROM, Flash, hard disk drive (HDD)) at the configuration database 270. As a result of complying with this configuration data, the ONT 230 may be considered to operate in two or more distinct modes. When the primary power source (i.e., AC line power) is available, the ONT 230 exhibits a “normal” operation. The ONT 230 in normal operation supports the full range of services available to the customer and enables all hardware required to support those services, as power availability is presumed not to be of concern. Regardless of power availability, the ONT 230 may undertake power-saving measures, such as disabling unused hardware components and terminating extraneous software processes, in order to improve energy efficiency. In response to the primary power source failing, the ONT 230 transitions to a “backup power” mode, which may include a number of different modes of operation based on BBU availability, status and other conditions as specified in the configuration data at the configuration database 270. Example configurations for operation are described below with reference to FIGS. 3A-3C, and example processes for configuration and operation in a “backup power” mode are described below with reference to FIGS. 4, 5A and 5B.

FIG. 2B is a block diagram of an Optical Network Terminal (ONT) 231, which may include components or perform operations of the ONT 230 described above with reference to FIG. 2A. The ONT 231 includes a memory 271 to store respective configuration data defining usage of power from multiple backup power sources (not shown) in the event of a loss of power from the primary power source. The circuitry 207 is configured to provide power to the ONT 231 by at least one of the multiple backup power sources based on the respective configuration data at the memory in the event of the loss of power from the primary power source

FIGS. 3A-C illustrate example configuration data for use of one or more BBUs in response to a primary power failure. A customer or service provider may access, review and modify such configuration data as described above. Moreover, additional categories of conditions or operations (e.g., may be appended to the configuration data to define further operation of an ONT or other device. For example, the configuration may include a priority of supported services, priority of BBUs to be used, or a time limit for availability of supported services. Further, the configuration can direct the ONT 230 to take actions in response to meeting particular conditions, including implementing “low power” modes, enabling and disabling hardware components of the ONT, reporting events such as a low battery and primary power failure, and communicating power status to the service provider or customer.

FIG. 3A is a table 300 illustrating an example configuration of services based on battery availability. In this configuration, each BBU coupled to the ONT (i.e., “service battery,” “user battery 1,” “user battery 2”) is associated with one or more services, including POTS, VoIP, Internet access (“Ethernet”) and IPTV. In the event of a power failure, the ONT detects which BBUs are available to provide battery backup power. For each BBU that is available (i.e., connected and contains sufficient charge), the ONT transitions to draw power from the BBU and enables (or continues to enable) its associated service(s). For example, all three batteries are associated with the POTS, meaning that ONT supports a telephone service to a customer in a “backup power” mode provided that at least one BBU is available. Conversely, the ONT is configured to support other services only if a particular battery is available. For example, if user battery 1 was previously available but is then removed or depletes its charge, the ONT disables the VoIP and Internet services, but maintains the telephone service so long as at least one of the service battery and user battery 2 are available. Such a configuration may be beneficial to a customer in that specific “backup power” services can be added and removed by removing and replacing associated batteries. Moreover, the table 300 may include multiple configurations, for example by assigning control over one portion of the table 300 to a service provider (e.g., service battery and associated services), and enabling a customer to modify another portion of the table 300 (e.g., user batteries and associated services). In this manner, the service provider can allow the customer to expand and customize backup power operations as desired, while still retaining control over the service battery to ensure a given support of a telephone service during a power failure.

FIG. 3B is a table 301 illustrating an example configuration of services based on availability of combinations of battery backup units (BBUs). In contrast to the table 300 of FIG. 3B, only one entry is selected by the ONT at a given time. Rather than associating each battery to a set of services, the ONT determines which BBUs are available, and then selects the entry in the left column corresponding to that availability. Every possible combination of available BBUs is indicated in a separate entry, and each entry is associated with a particular set of supported services. For example, if the ONT detects that the service battery (SB) and user battery 2 (UB2) are available, but user battery 1 (UB1) is unavailable, then the ONT will support the POTS, IPTV and Internet, and will disable support for other services. Such a configuration may be beneficial because the total services supported, and therefore total power consumption, can be configured to correspond to the total of BBUs available, ensuring that power usage is not disproportionate to available power.

FIG. 3C is a table 302 illustrating an example configuration of services determined by a selection of power levels and available BBUs. Each power level corresponds to a different state of power available to the ONT. In “AC Power” mode, the ONT receives sufficient power from a coupled AC line power source, and accordingly maintains “normal” operation and supports the full range of services available to the customer. If a total power failure occurs, where the AC line power and all BBUs become unavailable, then the ONT enters a “shutdown” mode that disables all services. When a primary power failure occurs and a BBU is available, then the ONT determines which batteries are available (as listed in the entries under “battery configuration”) and selects a corresponding power level, being one of power levels 1-4. For example, if BBUs SB and UB1 are detected as available, but UB2 is not, then the ONT selects “power level 2,” and enables or maintains POTS and Internet service while disabling all other services. The configuration as shown may be beneficial because it allows different combinations of BBUs to be arranged based on common power, charge, voltage or other capacities. For example, the BBU configuration (SB+UB1) may be grouped separately from the configurations (SB+UB2) and (UB1+UB2) due to the BBU UB2 having a greater charge capacity, thereby making such configurations more suitable for powering the total of the POTS, Internet and IPTV services.

FIG. 4 is a block diagram of a procedure 400 to configure services as a function of available BBUs. During or following installation of an ONT, a customer and/or service provider craft person installs one or more BBUs (405). With reference to FIG. 2A, for example, the BBUs may be installed by the customer or service provider and may be internal or external to the ONT, being comparable to one or more of the BBUs 280-283. Optionally, once the BBUs are installed, a revised BBU configuration may be reported to the service provider (410). This reporting may be omitted if the service provider does not need to be notified of the revised BBU configuration. The customer reviews the present service configuration, which may appear in a format comparable to the tables 300-302 in FIGS. 3A-3C. The customer modifies (or requests that the service provider modify) the service configuration according to customer preferences and in view of the currently installed BBUs (420). Upon completing selection of services and other variables (425), the configuration is stored at a database, such as the database 270 within the ONT 230 as illustrated in FIG. 2A. As described above with respect to FIG. 1, the reporting (410), reviewing (415), selection (420) and configuration (425, 430) may be facilitated by a telephone call, an interface at the ONT, a networked device at the customer's premises, or other means.

FIG. 5A is a block diagram of a procedure 500 to configure services to be supported by multiple BBUs and provide power in the event of a power failure. For a device connected to a first BBU and a second BBU, the device is first configured for use of the first BBU (560). The device is further configured for use of the second BBU (565). The first and second configurations may include configuration data described above with reference to FIGS. 1-4, and may be stored at the device or at another node. In the event of an AC power failure (570), the device implements at least one of the first and second BBUs, according to the stored configurations, to provide backup power for continued operations.

FIG. 5B is a block diagram of a procedure 501 to monitor power availability and utilize one or more BBUs according to stored configuration data. The process 501 may be completed by an ONT in any of the example embodiments described above, and instructions for completing the process 501 may be included in configuration data or integral to hardware or software of the ONT. At a normal operational state, the ONT monitors continually or periodically whether a primary AC power source is available (505). If so, the ONT maintains support of a full range of available services and monitors and charges any BBUs coupled to the ONT (510). If the primary AC power fails, the ONT may report the failure to a customer or service provider as required. The ONT then inquires, via a central processor or circuitry at the PSU, whether one or more BBUs are available (517). If not, the ONT shuts down (518). Indeed, an absence of AC power and battery backup may cause the ONT to become inactive before it has the opportunity to make the above inquiry and enter a shutdown sequence. If one or more BBUs are available, then the ONT determines the availability and status of BBUs coupled to the ONT. The ONT may further collect any other information regarding the BBUs or the status of the ONT itself as required by stored configuration data. For example, the configuration data may utilize information on the approximate charge of the available BBU, as well as information regarding power consumption of the OLT, in determining corresponding actions and supported services.

Based on this collected information, the OLT selects a corresponding configuration from the stored configuration data (522). In addition to taking actions as directed in the configuration (e.g., reporting an alert to a customer or service provider, disabling hardware components), the ONT requests the services as indicated in the configuration (525). If the ONT is not presently receiving a particular service, then the ONT may transmit an request upstream to a service provider for the service. Once all requested services are received, the ONT maintains support for those service between the service provider and customer installed equipment (530). Continually or periodically during such services, the ONT monitors whether the AC line power has been restored (535), and whether a change in battery status has occurred (536). If AC line power has been restored, the OLT resumes normal operation (510). A change in the battery status may include a loss of availability of one or more BBUs, a change in the charge status of a BBU (e.g., a battery has depleted a substantial charge), or a change in any other conditions that may affect the selection of a corresponding configuration from the configuration data. In response, the ONT returns to inquire whether a BBU is still available (517). If so, the ONT repeats the aforementioned configuration process 520-530 to reconfigure operations and supported services as required by the configuration data.

It should be understood that the block diagram of FIG. 2A, the tables of FIGS. 3A-3C, and the flow diagrams of FIGS. 4-5B are examples that can include more or fewer components, be partitioned into subunits, or be implemented in different combinations. Moreover, the flow diagrams may be implemented in hardware, firmware, or software. If implemented in software, the software may be written in any software language suitable for use in networks and network devices as illustrated in FIGS. 1-2. The software may be embodied on any form of computer readable medium, such as RAM, ROM, or magnetic or optical disk, and loaded and executed by generic or custom processor(s).

While this invention has been particularly shown and described with references to example embodiments thereof, it will be understood by those skilled in the art that various changes in form and details may be made therein without departing from the scope of the invention encompassed by the appended claims.

What is claimed is:

1. A method of managing backup power for a device, comprising:
in an event of a loss of primary power from a primary power source, providing power to a device by at least one of multiple backup power sources based on respective configuration data.

2. The method of claim 1, further comprising:
storing configuration data for use of a first backup power source;
storing configuration data for use of a second backup power source, the multiple backup power sources including the first and second backup power sources.

3. The method of claim 1 wherein providing power to the device includes providing power by multiple backup power sources in a serially coupled arrangement.

4. The method of claim 1 wherein the configuration data indicates a priority for use of one of the multiple backup power sources in providing power to the device.

5. The method of claim 1 wherein the configuration data is adapted for configuration by multiple users, each user controlling a subsection of the configuration data.

6. The method of claim 5 wherein one of the users is a service provider, and another one of the users is a customer of the service provider.

7. The method of claim 1 wherein the configuration data corresponding to one of the multiple backup power sources may be modified independent of the configuration data corresponding to another of the multiple backup power sources.

8. The method of claim 1 wherein storing the configuration data includes storing to a computer-readable medium.

9. The method of claim 8 wherein the computer-readable medium is at least one of a RAM, ROM, FLASH memory and a hard disk drive (HDD).

10. The method of claim 1, wherein the device is an optical network terminal (ONT).

11. The method of claim 1, further comprising charging at least one of the multiple backup power sources by power from the primary power source.

12. The method of claim 1, wherein the configuration data indicates one or more services to be supported by the device in the event of the primary power failure, the services associated with one or more of the multiple backup power sources.

13. The method of claim 1, further comprising:
detecting a set of one or more backup power sources available to the device;
locating an entry within the configuration data containing the set; and
configuring the device to support services corresponding to the set in the configuration data.

14. The method of claim 13, further comprising:
configuring the device to disable services that fail to correspond to the set in the configuration data.

15. The method of claim 1, wherein the configuration data includes parameters including one or more of: priority of supported services, priority of backup power sources to be used, and duration of supported services following the failure of the primary power source.

16. The method of claim 1, wherein the configuration data includes instructions indicating entry of low power modes, enabling and disabling of hardware components of the device, and communicating power status to a service provider or customer.

17. A system for managing backup power, comprising:
memory to store respective configuration data defining usage of power from multiple backup power sources in an event of a loss of primary power from a primary power source; and
circuitry to provide power to a device by at least one of the multiple backup power sources based on the respective configuration data in the event the loss of power from the primary power source.

18. The system of claim 17 wherein the memory includes a storage device to store the respective configuration data.

19. The system of claim 17 wherein the multiple backup power sources are serially coupled to each other.

20. The system of claim 17 wherein the configuration data indicates a priority for use of one of the backup power sources in providing power to the device.

21. The system of claim 17 wherein the configuration data is adapted to enable configuration by multiple users, each user controlling a subsection of the configuration data.

22. The system of claim 21 wherein one of the users is a service provider, and another one of the users is a customer of the service provider.

23. The system of claim 17 wherein the configuration data corresponding to one of the backup power sources may be modified independent of the configuration data corresponding to another of the backup power sources.

24. The method of claim 17 wherein the memory is at least one of a RAM, ROM, FLASH memory, or a hard disk drive (HDD).

25. The system of claim 17, wherein the device is an optical network terminal (ONT).

26. The system of claim 17, wherein at least one of the multiple backup power sources is adapted to be charged by power from the primary power source.

27. The system of claim 17, wherein the configuration data indicates one or more services to be supported by the device in the event of the primary power failure, the services associated with one or more of the backup power sources.

28. The system of claim 17, wherein the circuitry is configured to detect a set of the multiple backup power sources is available to the device, locate an entry within the configuration data containing the set, and configure the device to support services corresponding to the set in the configuration data.

29. The system of claim 28, wherein the circuitry configures the device to disable services that fail to correspond to the set in the configuration data.

30. The system of claim 17, wherein the configuration data includes parameters including one or more of: priority of supported services, priority of backup power sources to be used, and duration of supported services following the failure of the primary power source.

31. The system of claim 17, wherein the configuration data includes instructions indicating entry of low power modes, enabling and disabling of hardware components of the device, and communicating power status to a service provider or customer.
